(19) United States
(12) Patent Application Publication
(10) Pub. No.: US 2023/0259711 A1
(43) Pub. Date: Aug. 17, 2023

(54) TOPIC LABELING BY SENTIMENT POLARITY IN TOPIC MODELING

(71) Applicant: International Business Machines Corporation, Armonk, NY (US)

(72) Inventors: Takuya Goto, Kodaira-shi (JP); Yoshiroh Kamiyama, Setagaya-ku (JP)

(21) Appl. No.: 17/669,484

(22) Filed: Feb. 11, 2022

(51) Int. Cl. G06F 40/30; G06F 40/242; G06F 40/289; G06F 40/117

(52) U.S. Cl. CPC G06F 40/30; G06F 40/242; G06F 40/289; G06F 40/117

(57) ABSTRACT

Described are techniques for topic modeling including a computer-implemented method of generating a plurality of topic labels corresponding to a plurality of documents clustered into a plurality of topics, where the plurality of topic labels include a sentiment-oriented topic label and a sentiment-neutral topic label. The method further comprises calculating term frequency-inverse document frequency (TF-IDF) values for respective topic labels and corresponding pluralities of documents. The method further comprises receiving a selected sentiment polarity from a user device. The method further comprises identifying a subset of the plurality of topic labels that satisfy the selected sentiment polarity. The method further comprises transmitting at least one topic label of the subset of the plurality of topic labels to the user device, where the at least one topic label has a higher TF-IDF value than other topic labels in the subset of the plurality of topic labels.

### BACKGROUND

The present disclosure relates to topic modeling in data processing systems, and, more specifically, to generating customized topic labels for a corpus of documents based on a selected sentiment polarity.

Topic modeling can be considered a machine learning and/or natural language processing (NLP) task. More specifically, topic modeling is a statistical latent semantic technique that can be used to categorize documents by grouping documents based on co-occurrences of latent semantic concepts (e.g., topics). Topic modeling can be used as a text-mining tool for content discovery in a large corpus of text. Once documents are grouped into distinct topics, topic labels can be generated to summarize the information of each grouped set of documents. Depending on the nature of the documents and the topic modeling technique, some topic labels can include sentiment (e.g., positive, negative, neutral, etc.).

Sentiment analysis is another NLP task with the purpose of estimating a sentiment (e.g., positive, negative, or neutral) for words, phrases, sentences, or documents. However, sentiment can interfere with topic modeling. For example, some existing topic modeling techniques can generate topic labels that include one sentiment despite the generated topic labels being based on content that also includes contradictory sentiments. As one example, a topic label including one sentiment (e.g., “Wi-Fi speed fast”) could be generated from customer review inputs that also include contradictory sentiments (e.g., “their Wi-Fi is not very fast,” and “the Wi-Fi is slow, but wired LAN is much faster”). Accordingly, current topic modeling techniques can mis-represent sentiment.

Further, in some instances, users prefer sentiment-agnostic or sentiment-neutral topic labels in topic modeling. Conventionally, such preferences have been met by removing any topic label with sentiment (and its corresponding clustered set of documents) from consideration for the sentiment-agnostic or sentiment-neutral topic labels. However, this strategy wholly eliminates potentially relevant information from consideration. Thus, current topic modeling techniques for generating dynamic topic labels based on a preferred sentiment polarity are lacking.

### SUMMARY

Aspects of the present disclosure are directed toward a computer-implemented method comprising generating a plurality of topic labels corresponding to a plurality of documents clustered into a plurality of topics, where the plurality of topic labels include a sentiment-oriented topic label and a sentiment-neutral topic label. The method further comprises calculating term frequency-inverse document frequency (TF-IDF) values for respective topic labels and corresponding pluralities of documents. The method further comprises receiving a selected sentiment polarity from a user device. The method further comprises identifying a subset of the plurality of topic labels that satisfy the selected sentiment polarity. The method further comprises transmitting at least one topic label of the subset of the plurality of topic labels to the user device, where the at least one topic label has a higher TF-IDF value than other topic labels in the subset of the plurality of topic labels.

Advantageously, the aforementioned method improves topic modeling by identifying topic labels that satisfy a selected sentiment polarity. Furthermore, the aforementioned method improves topic modeling by differentiating relatively more useful topic labels from relatively less useful topic labels according a TF-IDF values of the topic labels.

Further aspects of the present disclosure including the aforementioned method further include the selected sentiment polarity being a neutral sentiment polarity, and where the method further comprises generating a converted corresponding sentiment-neutral topic label corresponding to the sentiment-oriented topic label.

Advantageously, the aforementioned aspect of the present disclosure improves topic modeling by converting sentiment-oriented topic labels to sentiment-neutral topic labels in response to user queries for topic labels without sentiment. Doing so preserves useful information associated with the sentiment-oriented topic label while altering the sentiment-oriented topic label into a form satisfying the sentiment preference of the user query.

Further aspects of the present disclosure including the aforementioned method further include the selected sentiment polarity being a non-neutral sentiment polarity, and where the method further comprises removing topic labels with sentiments that do not match the non-neutral sentiment polarity from the plurality of topic labels. Advantageously, the aforementioned aspect of the present disclosure improves topic modeling by selectively removing topic labels with sentiment characteristics that do not match a preferred sentiment of a user query.

Further aspects of the present disclosure including the aforementioned method further comprise tagging respective documents with respective sentiment tags, and removing documents from the plurality of documents with sentiment tags that do not match the non-neutral sentiment polarity.

Advantageously, the aforementioned aspect of the present disclosure improves topic modeling by selectively removing documents with sentiment characteristics that do not match a preferred sentiment of a user query. In particular, these aspects of the present disclosure can remove documents that are inconsistent with the preferred sentiment of the user query even when those documents are associated with a topic label that satisfies the user query. Collectively, this results in more accurate and useful information being provided to the user.

Further aspects of the present disclosure are directed toward a computer-implemented method comprising generating a sentiment-neutral topic label for a first plurality of documents clustered into a first topic. The method further comprises generating a sentiment-oriented topic label for a second plurality of documents clustered into a second topic. The method further comprises receiving a selected sentiment polarity from a user device, where the selected sentiment polarity is a neutral sentiment polarity. The method further comprises generating a converted corresponding sentiment-neutral topic label corresponding to the sentiment-oriented topic label. The method further comprises transmitting the sentiment-neutral topic label and the converted corresponding sentiment-neutral topic label to the user device, where the sentiment-neutral topic label and the converted corresponding sentiment-neutral topic label are ranked by term frequency-inverse document frequency (TF-IDF) values.

Advantageously, the aforementioned method improves topic modeling by identifying topic labels that satisfy a selected sentiment polarity. Furthermore, the aforementioned method improves topic modeling by differentiating relatively more useful topic labels from relatively less useful topic labels according to TF-IDF values of the topic labels. Furthermore, the aforementioned method further improves topic modeling by converting sentiment-oriented topic labels to sentiment-neutral topic labels in response to user queries for topic labels without sentiment. Doing so preserves useful information associated with the sentiment-oriented topic label while altering the sentiment-oriented topic label into a form satisfying the sentiment preference of the user query.

Further aspects of the present disclosure are directed toward a computer-implemented method comprising generating a plurality of topic labels corresponding to a plurality of documents clustered into a plurality of topics, where the plurality of topic labels include a sentiment-oriented topic label and a sentiment-neutral topic label. The method further comprises calculating term frequency-inverse document frequency (TF-IDF) values for respective topic labels and corresponding pluralities of documents. The method further comprises removing topic labels from the plurality of topic labels that have a sentiment differing from a corresponding clustered set of documents. The method further comprises receiving a selected sentiment polarity from a user device. The method further comprises determining a subset of the plurality of topic labels that satisfy the selected sentiment polarity to the user device. The method further comprises presenting the subset of the plurality of topic labels according to the TF-IDF values.

Advantageously, the aforementioned method improves topic modeling by identifying topic labels that satisfy a selected sentiment polarity. Furthermore, the aforementioned method improves topic modeling by differentiating relatively more useful topic labels from relatively less useful topic labels according to TF-IDF values of the topic labels. Further still, the aforementioned method improves topic modeling by removing topic labels having contradictory sentiment compared to the corresponding clustered set of documents, thereby increasing the accuracy of the topic labels.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment including a topic model capable of dynamically generating topic labels based on preferred sentiment polarities, in accordance with some embodiments of the present disclosure.

FIG. 2 illustrates a flowchart of an example method for preprocessing a corpus of documents by a topic modeler capable of dynamically generating topic labels based on preferred sentiment polarities, in accordance with some embodiments of the present disclosure.

FIG. 3 illustrates a flowchart of an example method for dynamically generating topic labels based on preferred sentiment polarities, in accordance with some embodiments of the present disclosure.

FIG. 4 illustrates a flowchart of another example method for dynamically generating topic labels based on preferred sentiment polarities, in accordance with some embodiments of the present disclosure.

FIG. 5 illustrates a flowchart of an example method for dynamically generating sentiment-neutral topic labels using both sentiment-neutral and sentiment-oriented information, in accordance with some embodiments of the present disclosure.

FIG. 6 illustrates a flowchart of an example method for downloading, deploying, metering, and billing usage of a topic model configured to dynamically generate topic labels based on preferred sentiment polarities, in accordance with some embodiments of the present disclosure.

FIG. 7 illustrates an example sentiment dictionary associating sentiment-oriented text with sentiment-neutral text, in accordance with some embodiments of the present disclosure.

FIG. 8 illustrates an example table including topic labels and corresponding clustered sets of documents, in accordance with some embodiments of the present disclosure.

FIG. 9 illustrates a block diagram of an example computer, in accordance with some embodiments of the present disclosure.

FIG. 10 depicts a cloud computing environment, in accordance with some embodiments of the present disclosure.

FIG. 11 depicts abstraction model layers, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward topic modeling in data processing systems, and, more specifically, to generating customized topic labels for a corpus of documents based on a selected sentiment polarity. While not limited to such applications, embodiments of the present disclosure may be better understood in light of the aforementioned context.

First, it should be noted that algorithms of topic modeling do not typically contain a method to label identified topics (e.g., Latent Dirichlet Allocation (LDA), Latent Semantic Indexing (LSI)). However, in this disclosure, the phrase topic modeling should be construed to mean either or both of an algorithm for topic modeling and/or a labeling method.

Second, aspects of the present disclosure utilize term frequency-inverse document frequency (TF-IDF) values of candidate topic labels to differentiate relatively more accurate, useful, and/or otherwise meaningful candidate topic labels from relatively less accurate, useful, and/or meaningful candidate topic labels. TF-IDF is a numerical statistic that can reflect an importance of a token to one or more documents within a corpus of documents. TF-IDF increases proportionally to the number of times a token appears in a given document and the TF-IDF value is decreased as the number of documents in a corpus that contain the token increases. In some embodiments, TF-IDF can be defined according to Equation 1:

TF−IDF_{i,j}=TF_{i,j}·IDFᵢ Equation 1:

As shown in Equation 1, the TF-IDF can be the term frequency (TF) multiplied by the inverse document frequency (IDF). In Equation 1, the term i can refer to a token, and the term j can refer to a topic. As used herein, a token can refer to a word, phrase, sentence, or other subset of a document that can be useful as a topic label. TF can be defined according to Equation 2:

$${TF}_{i , j} = \frac{{n}_{i , j}}{{\sum }_{{i}^{′}} {n}_{{i}^{′} , j}} \qquad Equation 2$$

In Equation 2, the numerator can refer to the number of times a token, wᵢ, occurs in a topic, tⱼ. The denominator of Equation 2 can refer to the sum of all tokens related to the topic. Referring back to Equation 1, the IDF term can measure how much information a given token provides given how common it is across all documents in a corpus. IDF can be defined according to Equation 3:

$${IDF}_{i} = log \frac{\vert T \vert}{\vert \{ t ∈ T : t ∋ {w}_{i} \} \vert} \qquad Equation 3$$

In Equation 3, the numerator |T| can refer to the total count of topics and the denominator can refer to the total count of topics containing token wᵢ. The IDF is the log of the quotient.

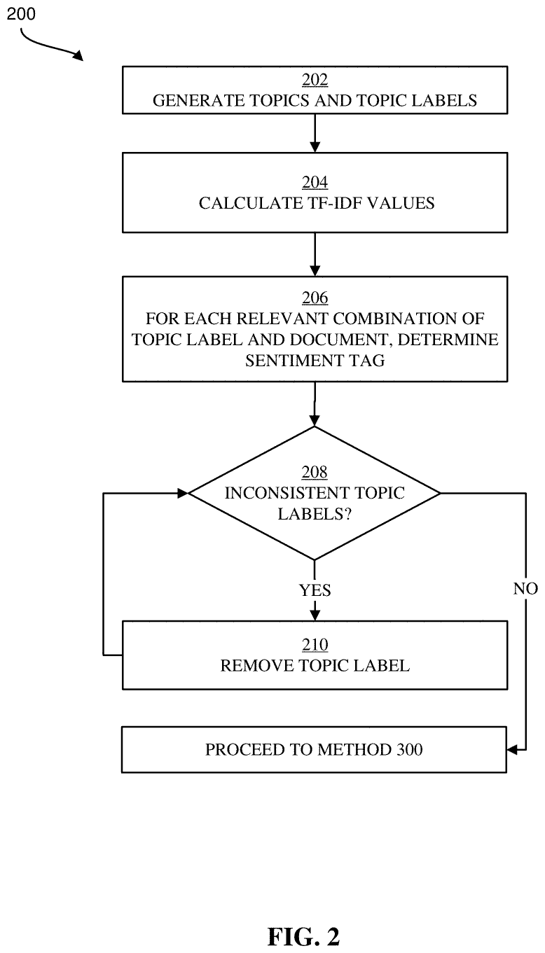

More generally, aspects of the present disclosure are configured to provide topic labels based on a user's preferred sentiment polarity. In some embodiments, aspects of the present disclosure first perform pre-processing by generating topics (by clustering documents of a corpus of documents) and topic labels (where the topic labels reflect, in a human-digestible form, the content of the respective clustered sets of documents). Pre-processing can further include characterizing sentiments of the topic labels and underlying documents, removing contradictions between topic labels and documents in topics, and calculating TF-IDF values for respective topic labels and their corresponding clustered set of documents (where each clustered set of documents defines a topic). Preprocessing is discussed in more detail with respect to FIG. 2.

After pre-processing, aspects of the present disclosure can provide customized topic labels in response to a user-selected sentiment polarity. For example, if a user prefers sentiment-neutral or sentiment-agnostic topic labels, aspects of the present disclosure can replace sentiment-oriented topic labels with sentiment-neutral topic labels. Regardless of whether a user prefers topic labels with or without a certain sentiment polarity, aspects of the present disclosure do not need to retrain the topic model to dynamically generate topic labels that satisfy the user's sentiment polarity preference. Further still, regardless of whether a user prefers topic labels with or without a certain sentiment polarity, aspects of the present disclosure can provide the customized topic labels based on TF-IDF values. Using TF-IDF values can be useful for selecting, ranking, or otherwise identifying relatively more accurate, useful, and/or otherwise meaningful topic labels for the customized topic labels that satisfy the selected sentiment polarity.

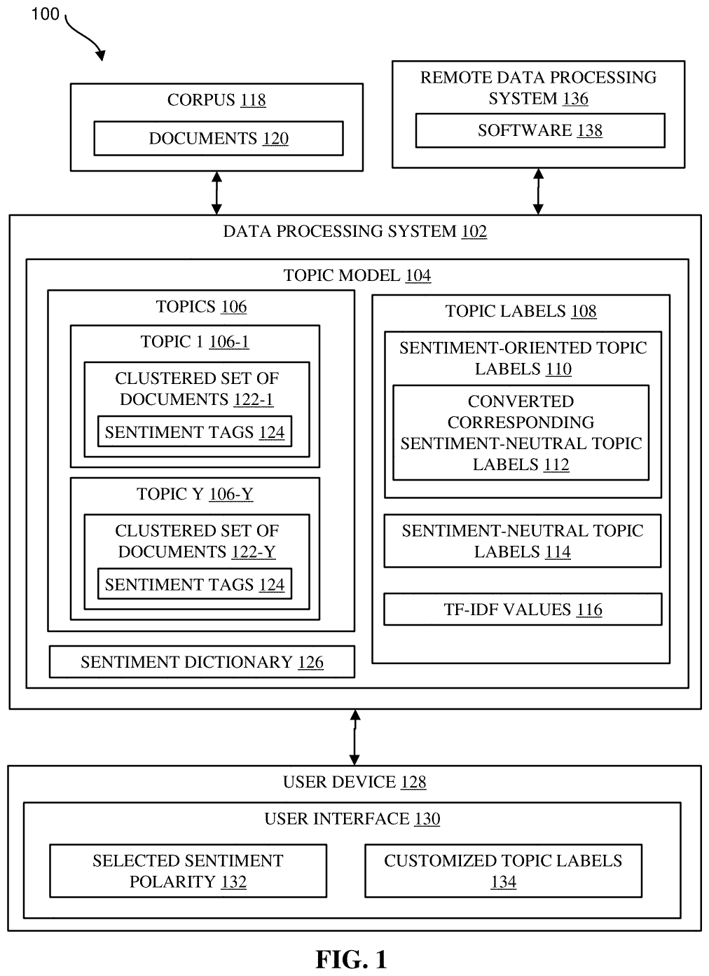

Referring now to the figures, FIG. 1 illustrates a block diagram of an example computational environment 100 including a topic model 104 capable of dynamically generating customized topic labels 134 based on preferred sentiment polarities, in accordance with some embodiments of the present disclosure. The computational environment 100 includes a data processing system 102 communicatively coupled to a user device 128, a corpus 118, and a remote data processing system 136. The data processing system 102 and remote data processing system 136 can be any type of computational system, physical or virtual, now known or later developed such as, but not limited to, one or more servers, processors, computers, desktops, laptops, tablets, and/or other devices.

The data processing system 102 can include a topic model 104 configured to dynamically generate customized topic labels 134 based on preferred sentiment polarities. The topic model 104 can evaluate numerous documents 120 in a corpus 118 to identify topics 106. Topics 106 can generally be referred to by the variable tⱼ herein, and documents 120 can generally be referred to by the variable dₖ herein. As will be appreciated by one skilled in the art, topics 106 can be formed from clustered sets of documents 122. For example, a topic 1 106-1 can be made up of a first clustered set of documents 122-1. The topic model 104 can generate any number of topics 106, and this is reflected by a y^{th} topic Y 106-Y which is defined by a y^{th} clustered set of documents 122-Y where Y can refer to any positive integer. Accordingly, the topics 106 generated by the topic model 104 do not include any readily understandable information that would enable a user to quickly understand the nature of each topic 106. Accordingly, aspects of the present disclosure generate topic labels 108. There can be at least one (and in some cases, only one) topic label 108 for each topic 106.

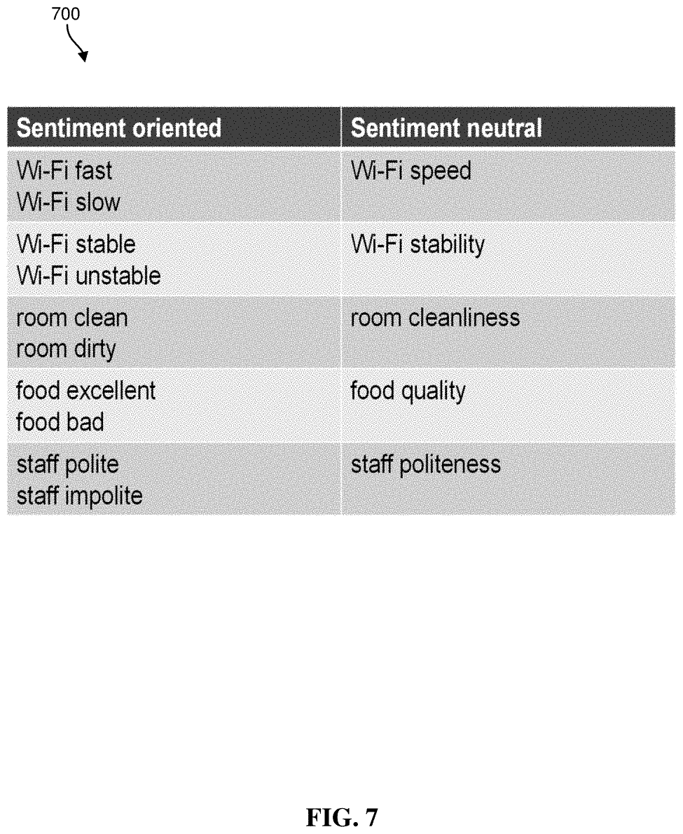

As previously discussed, some topic labels 108 include sentiment, such as sentiment-oriented topic labels 110 (e.g., “good WiFi”) whereas other topic labels 108 are do not include sentiment or are otherwise sentiment neutral, such as sentiment-neutral topic labels 114 (e.g., “WiFi”). Some aspects of the present disclosure are configured to generate a converted corresponding sentiment-neutral topic label 112 for each sentiment-oriented topic label 110, thereby enabling users that do not wish to have sentiment included in topic labels 108 to view a converted corresponding sentiment-neutral topic label 112 (and corresponding clustered set of documents 122) that would otherwise be removed from consideration. In some embodiments, sentiment-oriented topic labels 110 are converted to converted corresponding sentiment-neutral topic labels 112 using a sentiment dictionary 126. Sentiment dictionary 126 can be a table associating sentiment-oriented tokens (e.g., words or phrases) with sentiment-neutral tokens. An example sentiment dictionary 126 is discussed hereinafter with respect to FIG. 7.

The topic model 104 is further configured to generate TF-IDF values 116 for respective combinations of topic labels 108 and clustered sets of documents 122 (corresponding to topics 106). Advantageously, TF-IDF values 116 can reflect a relative importance of a topic label 108 to one or more documents in a clustered set of documents 122, thereby serving as a metric by which to determine accurate, relevant, and/or useful topic labels 108 for respective clustered sets of documents 122.

The topic model 104 is further configured to generate one or more sentiment tags 124 for respective documents in respective clustered sets of documents 122. In some embodiments, sentiment tags 124 reflect a sentiment of a topic label 108 (e.g., a sentiment-oriented topic label 110 or a sentiment-neutral topic label 114), where the sentiment of the topic label 108 can be applied to all documents in a corresponding clustered set of documents 122 via the sentiment tag 124. In some embodiments, sentiment tags 124 are independently derived for each document in a clustered set of documents 122 regardless of any sentiment (or lack thereof) associated with the topic label 108 of the clustered set of documents 122.

As used herein, documents 120 can be any amount of text derived from any source. In some embodiments, documents 120 can be unstructured text. In some embodiments, individual documents 120 can vary in size such as phrases or sentences (e.g., online user reviews), paragraphs or pages (e.g., blog posts, journal articles, etc.), and/or books or manuals.

The computational environment 100 further includes a user device 128 communicatively coupled to the data processing system 102. The user device 128 can be a computer, desktop, laptop, tablet, smartphone, or other device with physical or virtualized computational resources collectively capable of sending information to, and receiving information from, the topic model 104. User device 128 includes a user interface 130. The user interface 130 can be any graphical user interface (GUI) now known or later developed. The user interface 130 can be configured to receive a selected sentiment polarity 132, transmit the selected sentiment polarity 132 to the topic model 104 of the data processing system 102, receive a transmission of customized topic labels 134 from the topic model 104 of the data processing system 102, and present the customized topic labels 134 on the user interface 130 of the user device 128. In some embodiments, the customized topic labels 134 are a subset of the topic labels 108. In some embodiments, the customized topic labels 134 can be presented according to the TF-IDF values 116 of the customized topic labels 134 (e.g., a topic label 108 with a relatively higher TF-IDF value 116 presented with greater emphasis than another topic label 108 with a relatively lower TF-IDF value 116).

Advantageously, aspects of the present disclosure enable a user of the user device 128 to receive customized topic labels 134 based on the selected sentiment polarity 132. For example, if the user wishes to view topic labels 108 without sentiment (e.g., a neutral sentiment), then the customized topic labels 134 can include both sentiment-neutral topic labels 114 (e.g., those topic labels 108 that were originally sentiment-neutral) and converted corresponding sentiment-neutral topic labels 112 (e.g., those topic labels 108 that were originally sentiment-oriented topic labels 110). Doing so preserves information in topic labels 108 and/or documents 120 that would otherwise be lost using conventional sentiment-scrubbing methods for topic labeling (e.g., removing sentiment-oriented topic labels 110 and/or corresponding clustered sets of documents 122 from consideration when a user desires to view topic labels 108 without sentiment).

Furthermore, if a user input a selected sentiment polarity 132 indicating that the user desired topic labels having sentiment (e.g., non-neutral sentiment, positive sentiment, negative sentiment, or a finer-grained selection of any of the aforementioned sentiments), then the customized topic labels 134 can include the sentiment-oriented topic labels 110 that satisfy the selected sentiment polarity 132.

In some embodiments, the computational environment further includes the remote data processing system 136 storing software 138. Software 138 can comprise processor-executable instructions for implementing topic model 104. In some embodiments, software 138 can be downloaded from the remote data processing system 136 to the data processing system 102 (or otherwise provisioned to the data processing system 102), and the usage of the software 138 to instantiate, execute, or otherwise implementing topic model 104 can be metered, and an invoice generated for the metered usage (e.g., Software as a Service (SaaS)).

FIG. 1 is an example configuration of computational environment 100, and other configurations are also possible and within the spirit and scope of the present disclosure. For example, although the corpus 118 and user device 128 are shown disparate from the data processing system 102, in other embodiments, one or both of the corpus 118 and the user device 128 are integrated within the data processing system 102.

FIG. 2 illustrates a flowchart of an example method 200 for preprocessing a corpus 118 of documents 120 by a topic model 104 capable of dynamically generating topic labels 108 based on a selected sentiment polarity 132, in accordance with some embodiments of the present disclosure. In some embodiments, the method 200 is performed by a processor, a computer, a user device (e.g., user device 128 of FIG. 1), a data processing system (e.g., data processing system 102 or remote data processing system 136 of FIG. 1), or another configuration of hardware and/or software.

Operation 202 includes identifying topics 106 and topic labels 108 associated with each topic 106. Each topic 106 can be defined by a clustered sets of documents 122, and topic labels 108 can be words and/or phrases semantically capturing the similarities of each clustered set of documents 122. In some embodiments, numerous candidate topic labels 108 are associated with each topic 106. Operation 202 can be performed using any machine learning techniques for topic modeling now known or later developed such as, but not limited to, LDA, LSI, Latent Semantic Analysis (LSA), Non-Negative Matrix Factorization (NMF), Parallel Latent Dirichlet Allocation (PLDA), Pachinko Allocation Model (PAM), and/or other topic modeling techniques. In embodiments where the techniques used to cluster documents into topics do not include generating topic labels 108, operation 202 can further include generating topic labels 108 by any topic label generation methods now known or later developed, such as, but not limited to, bag-of-words, word embeddings, word2vec, lda2vec, and the like.

Operation 204 includes calculating TF-IDF values 116 for respective combinations of topic label 108 and topics 106. More specifically, in some embodiments, operation 204 includes calculating TF-IDF values 116 for respective combinations of topic label 108 and clustered set of documents 122 corresponding to a topic 106. In some embodiments, operation 204 calculates a single TF-IDF value 116 for each topic label 108 based on all the documents in the corresponding clustered set of documents 122. In other embodiments, operation 204 calculates multiple TF-IDF values for each topic label 108 and each document in the corresponding clustered set of documents 122 and uses an average, median, or other single TF-IDF value 116 to reflect the multiple TF-IDF values. Regardless of whether the TF-IDF value 116 is based on a single value or a statistic of many values (e.g., average), the universe of documents used in determining the IDF term can be all the documents 120 in corpus 118 or all the documents in the clustered set of documents 122. Advantageously, TF-IDF values 116 can provide a measure of relative informational value of each topic label 108 to each clustered set of documents 122 forming a topic 106. Thus, TF-IDF values 116 can be used to differentiate relatively more useful from relatively less useful possible topic labels 108 for each topic 106.

Operation 206 iterates through various combinations of topic labels 108 and documents 120 (where each document 120 is associated with a topic 106 via a clustered set of documents 122). For each relevant combination of topic label 108 and document 120 (e.g., for combinations of topic label 108 and document 120 that are both associated with a same topic 106, or for topic labels 108 that appear in a document 120, etc.), operation 206 determines a sentiment tag 124 for the document 120. In some embodiments, the sentiment tag 124 reflects a sentiment of the topic label 108 (e.g., positive, negative, neutral, etc.), a sentiment derived from the document 120, a combination of the aforementioned, or a different measure of sentiment.

Operation 208 determines if there are any inconsistent topic labels 108. Inconsistent topic labels 108 can refer to topic labels 108 that have a sentiment that is contradictory, different, or otherwise inconsistent with sentiment in one or more documents of a clustered set of documents 122 associated with the topic label 108. In some embodiments, operation 208 relies on sentiment tags 124 of documents in a clustered set of documents 122 to compare sentiment of documents to sentiment of topic labels 108. In some embodiments, operation 208 can test the condition ∃i, s_{i,j,k}≠s_{i′,j,k}⊆i≠i′. In other words, operation 208 determines if there is any topic label 108 that includes a sentiment that is inconsistent with one or more sentiment tags 124 of one or more of the corresponding clustered sets of documents 122.

If so (210: YES), then the method 200 proceeds to operation 210 and removes the topic label 108 with contradictory sentiment. Advantageously, operation 210 can ensure that topic labels 108 reflect a sentiment that is consistent with the sentiment tags 124 of the corresponding clustered sets of documents 122, thereby removing sentiment-type contradictions between topic labels 108 and the clustered sets of documents 122 that they characterize. The method 200 then returns to operation 208. Referring back to operation 208, if there are no inconsistencies between sentiments of topic labels 108 and sentiment tags 124 of a corresponding clustered set of documents 122, (208: NO), then the method 200 proceeds to the method 300.

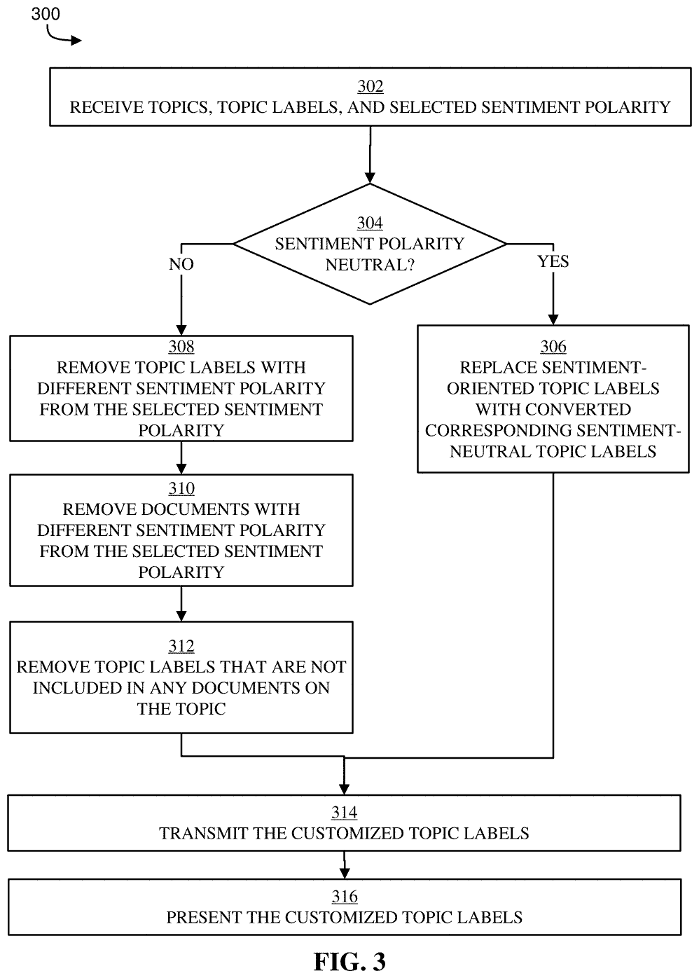

FIG. 3 illustrates a flowchart of an example method 300 for dynamically generating topic labels 108 based on a selected sentiment polarity 132, in accordance with some embodiments of the present disclosure. In some embodiments, the method 300 is performed by a processor, a computer, a user device (e.g., user device 128 of FIG. 1), a data processing system (e.g., data processing system 102 or data processing system 136 of FIG. 1), or another configuration of hardware and/or software. In some embodiments, the method 300 is performed following the method 200.

Operation 302 includes receiving topics 106, topic labels 108, and a selected sentiment polarity 132 at a topic model 104. In some embodiments, the selected sentiment polarity 132 is received from user device 128, where the selected sentiment polarity 132 is input to a user interface 130 of the user device 128. Topics 106 and topic labels 108 can be retrieved from the topic model 104 in response to performing the method 200 of FIG. 2.

Operation 304 includes determining if the selected sentiment polarity 132 is neutral. If so (304: YES), then the method 300 proceeds to operation 306 and replaces sentiment-oriented topic labels 110 with converted corresponding sentiment-neutral topic labels 112. In some embodiments, operation 306 utilizes a sentiment dictionary 126 to generate the converted corresponding sentiment-neutral topic labels 112 from the sentiment-oriented topic labels 110.

The method 300 then proceeds to operation 314 and transmits the customized topic labels 134 to the user device 128. Operation 316 includes presenting the customized topic labels 134 on the user interface 130 of the user device 128. In other words, for a neutral selected sentiment polarity 132, operation 316 can present some or all of the sentiment-neutral topic labels 114 and converted corresponding sentiment-neutral topic labels 112 as the customized topic labels 134 on the user interface 130 of user device 128. In some embodiments, the customized topic labels 134 presented in operation 316 are a predetermined number of sentiment-neutral topic labels 114 and/or converted corresponding sentiment-neutral topic labels 112 having a highest TF-IDF value 116 for each topic 106.

Advantageously, aspects of the present disclosure thus enable a user to indicate a preference for topic labels without sentiment (e.g., sentiment-neutral), and aspects of the present disclosure can generate and transmit customized topic labels 134 that include both the sentiment-neutral topic labels 114 (e.g., those topic labels 108 originally without sentiment) and converted corresponding sentiment-neutral topic labels 112 (e.g., sentiment-oriented topic labels 110 that were modified to be sentiment-neutral), thereby ensuring otherwise useful information in a clustered set of documents 122 associated with a sentiment-oriented topic label 110 is not omitted from the customized topic labels 134. Doing so improves the information value of the customized topic labels 134 relative to alternative methods, such as deleting sentiment-oriented topic labels 110 (and their corresponding clustered set of documents 122) based on a user preference for topic labels without sentiment. Furthermore, by ranking the customized topic labels 134 by TF-IDF values 116, aspects of the present disclosure can improve the quality of customized topic labels 134 insofar as TF-IDF values 116 can generally reflect the informational value of a topic label 108 to a set of clustered documents 122.

Referring back to operation 304, if the selected sentiment polarity 132 is not neutral (304: NO), then the method 300 proceeds to operation 308. Operation 308 includes removing topic labels 108 that have a different sentiment polarity from the selected sentiment polarity 132. For example, if a given topic label 108 has a positive sentiment and the selected sentiment polarity 132 is negative, then operation 308 can remove the given topic label 108 insofar as the sentiment of the given topic label 108 is inconsistent with the selected sentiment polarity 132. In various embodiments, operation 308 can remove topic labels 108 that differ in sentiment polarity from the selected sentiment polarity 132 by varying degrees. Returning to the above example, for a selected sentiment polarity 132 that is negative, a given topic label 108 with a neutral sentiment can be removed. As another example, for a selected sentiment polarity 132 that is slightly negative, a given topic label 108 with an extremely negative sentiment can be removed.

Operation 310 includes removing documents 120 from the corpus 118 that include a sentiment tag 124 that is different from the selected sentiment polarity 132. Advantageously, operation 310 ensures that documents 120 that have different sentiment from the selected sentiment polarity 132 are removed (even if those documents 120 fall within a clustered set of documents 122 associated with a topic label 108 that otherwise corresponds to the selected sentiment polarity 132).

Operation 312 includes removing topic labels 108 that are not included in any clustered set of documents 122 related to a topic 106. For example, if all documents in a clustered set of documents 122 are removed in operation 310, then operation 312 can ensure that the corresponding topic label 108 is also removed (even if the corresponding topic label 108 has a sentiment otherwise satisfying the selected sentiment polarity 132).

The method 300 then proceeds to operations 314 and 316 to transmit and present the customized topic labels 134. For the embodiments where the selected sentiment polarity 132 is not neutral, the customized topic labels 134 can include a predetermined number of sentiment-oriented topic labels 110 (remaining after operations 308-312) having a highest TF-IDF value 116 for each topic 106.

Advantageously, the method 300 thus enables aspects of the present disclosure to identify and select customized topic labels 134 matching a non-neutral selected sentiment polarity 132, thereby enabling a user to query topics with a certain sentiment. Furthermore, as previously discussed with respect to a neutral selected sentiment polarity 132, by ranking the customized topic labels 134 by TF-IDF values 116, aspects of the present disclosure can improve the quality of customized topic labels 134 insofar as TF-IDF values 116 can generally reflect the informational value of a topic label 108 to a set of clustered documents 122.

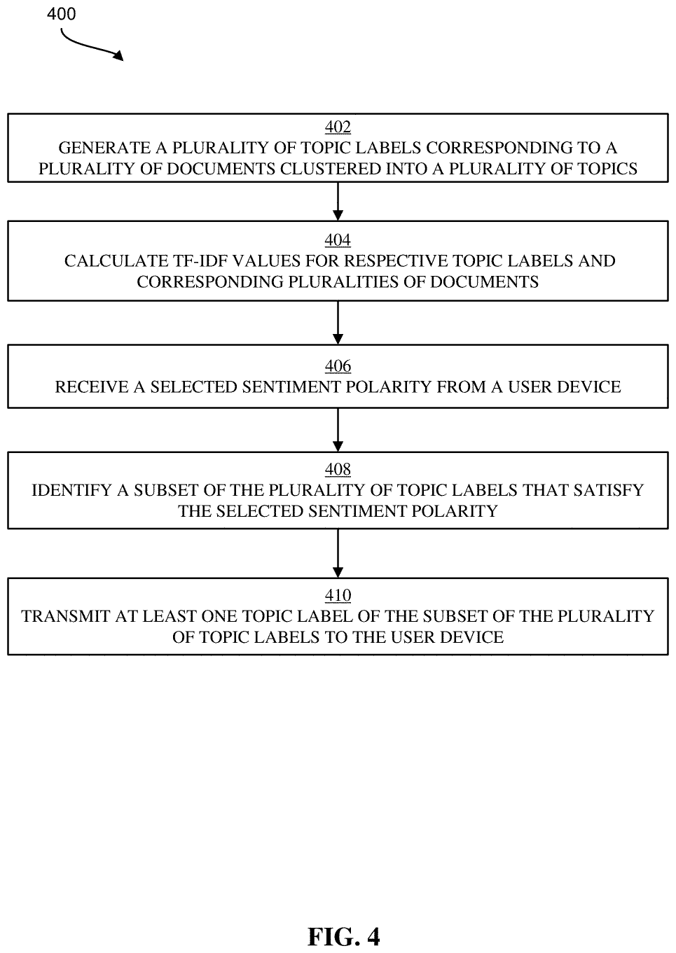

FIG. 4 illustrates a flowchart of another example method 400 for dynamically generating topic labels 108 based on preferred sentiment polarities, in accordance with some embodiments of the present disclosure. In some embodiments, the method 400 is performed by a processor, a computer, a user device (e.g., user device 128 of FIG. 1), a data processing system (e.g., data processing system 102 or remote data processing system 136 of FIG. 1), or another configuration of hardware and/or software.

Operation 402 includes generating a plurality of topic labels 108 corresponding to a plurality of documents (e.g., clustered set of documents 122) clustered into a plurality of topics 106. In some embodiments, the plurality of topic labels 108 include at least one sentiment-oriented topic label 110 and at least one sentiment-neutral topic label 114.

Operation 404 includes calculating TF-IDF values 116 for respective topic labels 108 and corresponding clustered sets of documents 122. Operation 406 includes receiving a selected sentiment polarity 132 from a user device 128. Operation 408 includes identifying a subset of the plurality of topic labels 108 that satisfy the selected sentiment polarity 132. Operation 410 includes transmitting at least one topic label 108 of the subset of the plurality of topic labels 108 to the user device 128, where the at least one topic label 108 has a higher TF-IDF value 116 than other topic labels 108 in the subset of the plurality of topic labels 108.

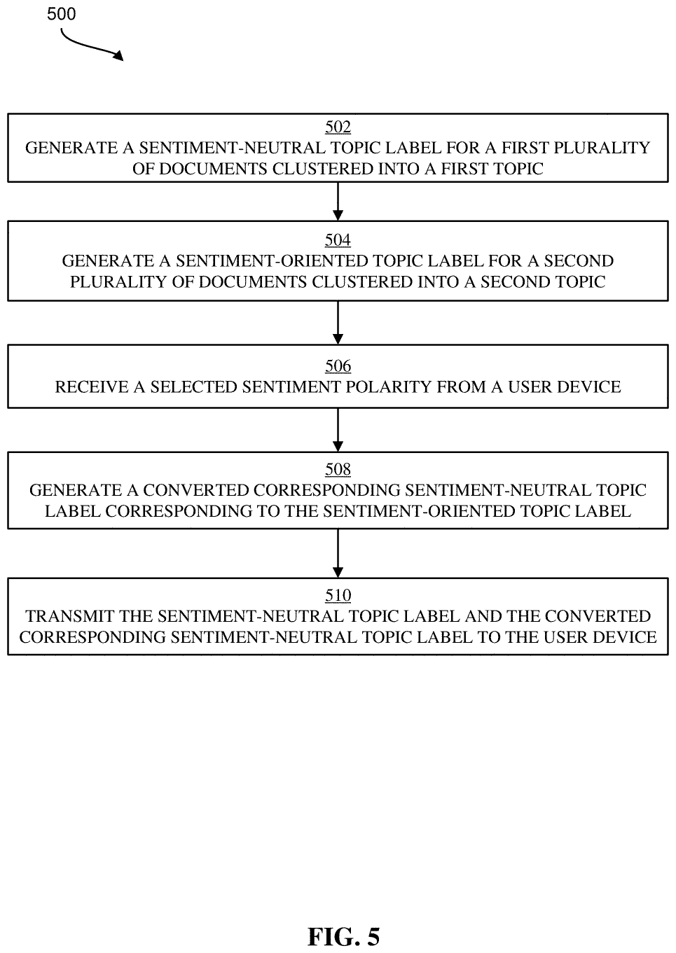

FIG. 5 illustrates a flowchart of an example method 500 for dynamically generating sentiment-neutral topic labels 114 using both sentiment-neutral and sentiment-oriented information, in accordance with some embodiments of the present disclosure. In some embodiments, the method 500 is performed by a processor, a computer, a user device (e.g., user device 128 of FIG. 1), a data processing system (e.g., data processing system 102 or remote data processing system 136 of FIG. 1), or another configuration of hardware and/or software.

Operation 502 includes generating a sentiment-neutral topic label 114 for a first plurality of documents 120 clustered into a first topic 106 via a first clustered set of documents 122. Operation 504 includes generating a sentiment-oriented topic label 110 for a second plurality of documents 120 clustered into a second topic 106 via a second clustered set of documents 122. Operation 506 includes receiving a selected sentiment polarity 132 from a user device 128, where the selected sentiment polarity 132 is a neutral sentiment polarity. Operation 508 includes generating a converted corresponding sentiment-neutral topic label 112 corresponding to the sentiment-oriented topic label 110. Operation 510 includes transmitting the sentiment-neutral topic label 114 and the converted corresponding sentiment-neutral topic label 112 to the user device 128, where the sentiment-neutral topic label 114 and the converted corresponding sentiment-neutral topic label 112 are ranked by TF-IDF values 116. In some embodiments, operation 510 includes calculating a first TF-IDF value 116 based on the sentiment-neutral topic label 114 and the first clustered set of documents 122. In some embodiments, operation 510 includes calculating a second TF-IDF value 116 based on the second clustered set of documents 122 and the sentiment-oriented topic label 110, the converted corresponding sentiment-neutral topic label 112, or a combination of the two.

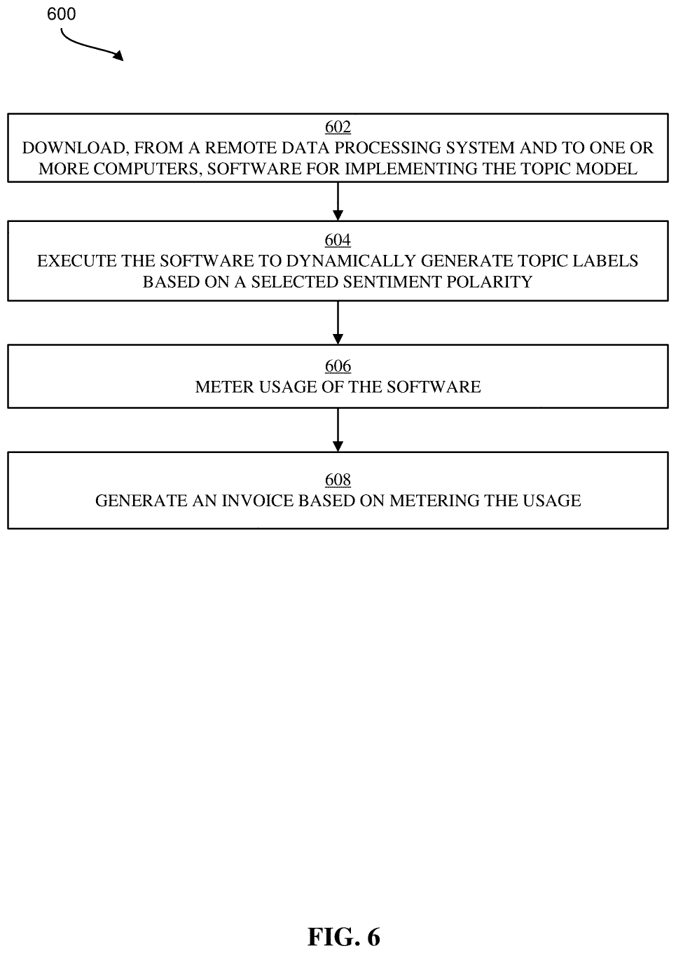

FIG. 6 illustrates a flowchart of an example method 600 for downloading, deploying, metering, and billing usage of a topic model 104 configured to dynamically generate topic labels 108 based on preferred sentiment polarities, in accordance with some embodiments of the present disclosure. In some embodiments, the method 600 is performed by a processor, a computer, a user device (e.g., user device 128 of FIG. 1), a data processing system (e.g., data processing system 102 or remote data processing system 136 of FIG. 1), or another configuration of hardware and/or software.

Operation 602 includes downloading, from a remote data processing system 136, and to one or more computers (e.g., data processing system 102, user device 128), software 138 for implementing the topic model 104. Operation 604 includes executing the software 138 to dynamically generate topic labels 108 based on a selected sentiment polarity 132 (e.g., implement topic model 104). Operation 606 includes metering usage of the software 138. Metered usage can be an amount of time the software 138 is used, a number of endpoints using the software 138, a number of distinct implementations of the software 138, a number of results (e.g., customized topic labels 134) generated by the software 138, an amount of computational resources deployed in support of executing the software 138, or another amount of usage. Operation 608 includes generating an invoice based on metering the usage of the software 138.

FIG. 7 illustrates an example sentiment dictionary 700 associating sentiment-oriented text with sentiment-neutral text for similar topics, in accordance with some embodiments of the present disclosure. In some embodiments, example sentiment dictionary 700 is consistent with sentiment dictionary 126 of FIG. 1. The example sentiment dictionary 700 includes associations between sentiment-oriented tokens (left column) and sentiment-neutral tokens (right column), where the tokens can refer to words or phrases suitable for a topic label 108. Advantageously, example sentiment dictionary 700 enables aspects of the present disclosure to convert sentiment-oriented topic labels 110 to converted corresponding sentiment-neutral topic labels 112, thereby preserving useful information from the sentiment-oriented topic labels 110 and/or corresponding clustered set of documents 122 for queries requesting sentiment-neutral information.

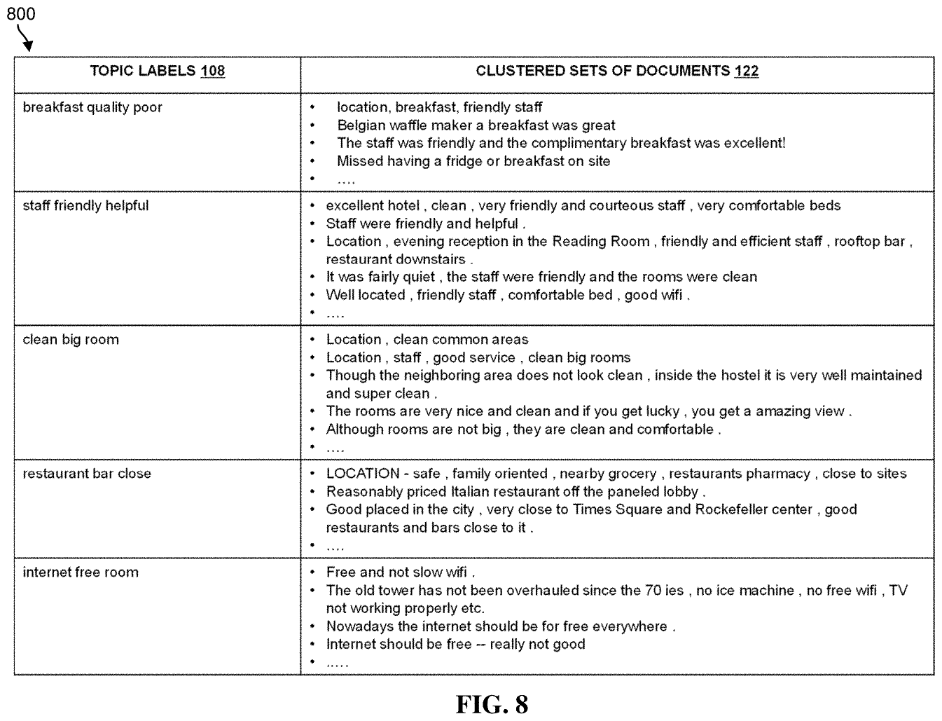

FIG. 8 illustrates an example table 800 including topic labels 108 and corresponding clustered sets of documents 122, in accordance with some embodiments of the present disclosure. Topic labels 108 can include both sentiment-oriented topic labels 110 and/or sentiment-neutral topic labels 114. In embodiments where the topic labels 108 in example table 800 reflect customized topic labels 134, the customized topic labels 134 can include sentiment-oriented topic labels 110, converted corresponding sentiment-neutral topic labels 112, and/or sentiment-neutral topic labels 114.

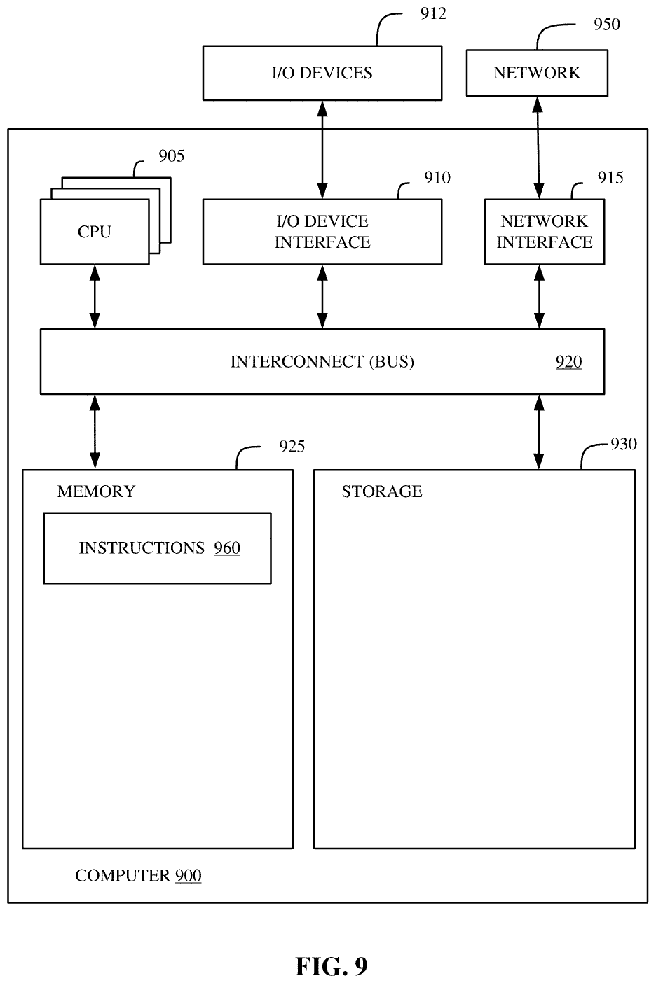

FIG. 9 illustrates a block diagram of an example computer 900 in accordance with some embodiments of the present disclosure. In various embodiments, computer 900 can perform any or all portions of the methods described in FIGS. 2-6 and/or implement the functionality discussed in FIGS. 1 and/or 7-8. In some embodiments, computer 900 receives instructions related to the aforementioned methods and functionalities by downloading processor-executable instructions from a remote data processing system (e.g., remote data processing system 136 of FIG. 1) via network 950. In other embodiments, computer 900 provides instructions for the aforementioned methods and/or functionalities to a client machine (e.g., data processing system 102 or user device 128 of FIG. 1) such that the client machine executes the method, or a portion of the method, based on the instructions provided by computer 900. In some embodiments, the computer 900 is incorporated into (or functionality similar to computer 900 is virtually provisioned to) one or more entities illustrated in FIG. 1 and/or other aspects of the present disclosure (e.g., remote data processing system 136, data processing system 102, user device 128, and/or corpus 118).

Computer 900 includes memory 925, storage 930, interconnect 920 (e.g., a bus), one or more CPUs 905 (also referred to as processors herein), I/O device interface 910, I/O devices 912, and network interface 915.

Each CPU 905 retrieves and executes programming instructions stored in memory 925 or storage 930. Interconnect 920 is used to move data, such as programming instructions, between the CPUs 905, I/O device interface 910, storage 930, network interface 915, and memory 925. Interconnect 920 can be implemented using one or more buses. CPUs 905 can be a single CPU, multiple CPUs, or a single CPU having multiple processing cores in various embodiments. In some embodiments, CPU 905 can be a digital signal processor (DSP). In some embodiments, CPU 905 includes one or more 3D integrated circuits (3DICs) (e.g., 3D wafer-level packaging (3DWLP), 3D interposer based integration, 3D stacked ICs (3D-SICs), monolithic 3D ICs, 3D heterogeneous integration, 3D system in package (3DSiP), and/or package on package (PoP) CPU configurations). Memory 925 is generally included to be representative of a random-access memory (e.g., static random-access memory (SRAM), dynamic random-access memory (DRAM), or Flash). Storage 930 is generally included to be representative of a non-volatile memory, such as a hard disk drive, solid state device (SSD), removable memory cards, optical storage, or flash memory devices. In an alternative embodiment, storage 930 can be replaced by storage area-network (SAN) devices, the cloud, or other devices connected to computer 900 via I/O device interface 910 or network 950 via network interface 915.

In some embodiments, memory 925 stores instructions 960. However, in various embodiments, instructions 960 are stored partially in memory 925 and partially in storage 930, or they are stored entirely in memory 925 or entirely in storage 930, or they are accessed over network 950 via network interface 915.

Instructions 960 can be computer-readable and computer-executable instructions for performing any portion of, or all of, the methods of FIGS. 2-6 and/or implement the functionality discussed in FIGS. 1 and/or 7-8. Although instructions 960 are shown in memory 925, instructions 960 can include program instructions collectively stored across numerous computer-readable storage media and executable by one or more CPUs 905.

In various embodiments, I/O devices 912 include an interface capable of presenting information and receiving input. For example, I/O devices 912 can present information to a user interacting with computer 900 and receive input from the user.

Computer 900 is connected to network 950 via network interface 915. Network 950 can comprise a physical, wireless, cellular, or different network.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

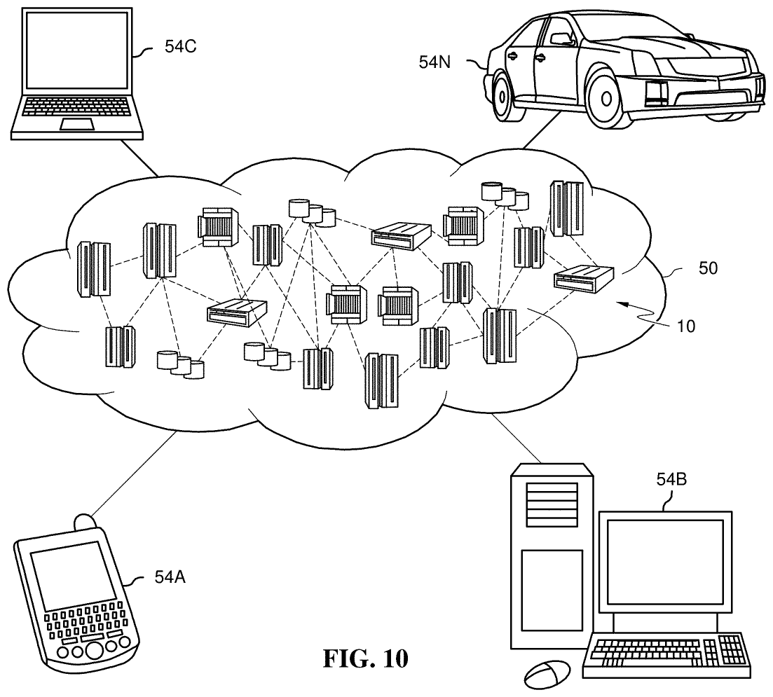

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

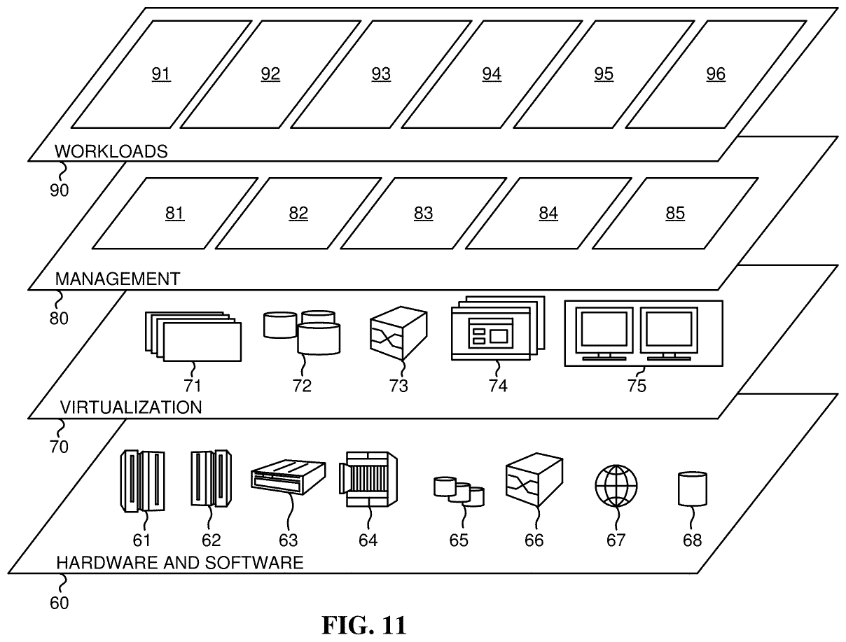

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dynamically generating topic labels based on a preferred sentiment polarity 96.

Embodiments of the present invention can be a system, a method, and/or a computer program product at any possible technical detail level of integration. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any of the instructions stored in instructions 960 of FIG. 9 and/or any software configured to perform any portion of the methods described with respect to FIGS. 2-6 and/or implement the functionality discussed in FIGS. 1 and/or 7-8 can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes generating a plurality of topic labels corresponding to a plurality of documents clustered into a plurality of topics, wherein the plurality of topic labels include a sentiment-oriented topic label and a sentiment-neutral topic label; calculating term frequency-inverse document frequency (TF-IDF) values for respective topic labels and corresponding pluralities of documents; receiving a selected sentiment polarity from a user device; identifying a subset of the plurality of topic labels that satisfy the selected sentiment polarity; and transmitting at least one topic label of the subset of the plurality of topic labels to the user device, wherein the at least one topic label has a higher TF-IDF value than other topic labels in the subset of the plurality of topic labels.

Example 2 includes the method of example 1, including or excluding optional features. In this example, the selected sentiment polarity comprises a neutral sentiment polarity, wherein the method further comprises: generating a converted corresponding sentiment-neutral topic label corresponding to the sentiment-oriented topic label. Optionally, the subset of the plurality of topic labels includes both the sentiment-neutral topic label and the converted corresponding sentiment-neutral topic label. Optionally, generating the converted corresponding sentiment-neutral topic label utilizes a sentiment dictionary associating sentiment-neutral phrases and sentiment-oriented phrases for similar topics.

Example 3 includes the method of any one of examples 1 to 2, including or excluding optional features. In this example, the selected sentiment polarity comprises a non-neutral sentiment polarity, wherein the method further comprises: removing topic labels with sentiments that do not match the non-neutral sentiment polarity from the plurality of topic labels. Optionally, the method further comprises: tagging respective documents with respective sentiment tags; and removing documents from the plurality of documents with sentiment tags that do not match the non-neutral sentiment polarity.

Example 4 includes the method of any one of examples 1 to 3, including or excluding optional features. In this example, the method is performed by one or more computers according to software that is downloaded to the one or more computers from a remote data processing system. Optionally, the method further comprises: metering a usage of the software; and generating an invoice based on metering the usage.

Example 5 is a computer-implemented method. The method includes generating a sentiment-neutral topic label for a first plurality of documents clustered into a first topic; generating a sentiment-oriented topic label for a second plurality of documents clustered into a second topic; receiving a selected sentiment polarity from a user device, wherein the selected sentiment polarity is a neutral sentiment polarity; generating a converted corresponding sentiment-neutral topic label corresponding to the sentiment-oriented topic label; and transmitting the sentiment-neutral topic label and the converted corresponding sentiment-neutral topic label to the user device, wherein the sentiment-neutral topic label and the converted corresponding sentiment-neutral topic label are ranked by term frequency-inverse document frequency (TF-IDF) values.

Example 6 includes the method of example 5, including or excluding optional features. In this example, generating the converted corresponding sentiment-neutral topic label utilizes a sentiment dictionary associating sentiment-neutral phrases and sentiment-oriented phrases for similar topics.

Example 7 includes the method of any one of examples 5 to 6, including or excluding optional features. In this example, the method is performed by one or more computers according to software that is downloaded to the one or more computers from a remote data processing system. Optionally, the method further comprises: metering a usage of the software; and generating an invoice based on metering the usage.

Example 8 is a computer-implemented method. The method includes generating a plurality of topic labels corresponding to a plurality of documents clustered into a plurality of topics, wherein the plurality of topic labels include a sentiment-oriented topic label and a sentiment-neutral topic label; calculating term frequency-inverse document frequency (TF-IDF) values for respective topic labels and corresponding pluralities of documents; removing topic labels from the plurality of topic labels that have a sentiment differing from a corresponding clustered set of documents; receiving a selected sentiment polarity from a user device; determining a subset of the plurality of topic labels that satisfy the selected sentiment polarity to the user device; and presenting the subset of the plurality of topic labels according to the TF-IDF values.

Example 9 is a system. The system includes one or more computer readable storage media storing program instructions; and one or more processors which, in response to executing the program instructions, are configured to perform a method according to any one of examples 1-8.

Example 10 is a computer program product. The computer program product includes one or more computer readable storage media, and program instructions collectively stored on the one or more computer readable storage media, the program instructions comprising instructions configured to cause one or more processors to perform a method according to any one of examples 1-8.

What is claimed is:

1. A computer-implemented method comprising:
generating a plurality of topic labels corresponding to a plurality of documents clustered into a plurality of topics, wherein the plurality of topic labels include a sentiment-oriented topic label and a sentiment-neutral topic label;
calculating term frequency-inverse document frequency (TF-IDF) values for respective topic labels and corresponding pluralities of documents;
receiving a selected sentiment polarity from a user device;
identifying a subset of the plurality of topic labels that satisfy the selected sentiment polarity; and
transmitting at least one topic label of the subset of the plurality of topic labels to the user device, wherein the at least one topic label has a higher TF-IDF value than other topic labels in the subset of the plurality of topic labels.

2. The method of claim 1, wherein the selected sentiment polarity comprises a neutral sentiment polarity, wherein the method further comprises:
generating a converted corresponding sentiment-neutral topic label corresponding to the sentiment-oriented topic label.

3. The method of claim 2, wherein the subset of the plurality of topic labels includes both the sentiment-neutral topic label and the converted corresponding sentiment-neutral topic label.

4. The method of claim 2, wherein generating the converted corresponding sentiment-neutral topic label utilizes a sentiment dictionary associating sentiment-neutral phrases and sentiment-oriented phrases for similar topics.

5. The method of claim 1, wherein the selected sentiment polarity comprises a non-neutral sentiment polarity, wherein the method further comprises:
removing topic labels with sentiments that do not match the non-neutral sentiment polarity from the plurality of topic labels.

6. The method of claim 5, wherein the method further comprises:
tagging respective documents with respective sentiment tags; and
removing documents from the plurality of documents with sentiment tags that do not match the non-neutral sentiment polarity.

7. The method of claim 1, wherein the method is performed by one or more computers according to software that is downloaded to the one or more computers from a remote data processing system.

8. The method of claim 7, wherein the method further comprises:
metering a usage of the software; and
generating an invoice based on metering the usage.

9. A system comprising:
one or more computer readable storage media storing program instructions; and
one or more processors which, in response to executing the program instructions, are configured to perform a method comprising:
generating a plurality of topic labels corresponding to a plurality of documents clustered into a plurality of topics, wherein the plurality of topic labels include a sentiment-oriented topic label and a sentiment-neutral topic label;
calculating term frequency-inverse document frequency (TF-IDF) values for respective topic labels and corresponding pluralities of documents;
receiving a selected sentiment polarity from a user device;
identifying a subset of the plurality of topic labels that satisfy the selected sentiment polarity; and
transmitting at least one topic label of the subset of the plurality of topic labels to the user device, wherein the at least one topic label has a higher TF-IDF value than other topic labels in the subset of the plurality of topic labels.

10. The system of claim 9, wherein the selected sentiment polarity comprises a neutral sentiment polarity, wherein the method further comprises:
generating a converted corresponding sentiment-neutral topic label corresponding to the sentiment-oriented topic label.

11. The system of claim 10, wherein the subset of the plurality of topic labels includes both the sentiment-neutral topic label and the converted corresponding sentiment-neutral topic label.

12. The system of claim 10, wherein generating the converted corresponding sentiment-neutral topic label utilizes a sentiment dictionary associating sentiment-neutral phrases and sentiment-oriented phrases for similar topics.

13. The system of claim 9, wherein the selected sentiment polarity comprises a non-neutral sentiment polarity, wherein the method further comprises:
removing topic labels with sentiments that do not match the non-neutral sentiment polarity from the plurality of topic labels.

14. The system of claim 13, wherein the method further comprises:
tagging respective documents with respective sentiment tags; and
removing documents from the plurality of documents with sentiment tags that do not match the non-neutral sentiment polarity.

15. A computer program product comprising one or more computer readable storage media, and program instructions collectively stored on the one or more computer readable storage media, the program instructions comprising instructions configured to cause one or more processors to perform a method comprising:
generating a plurality of topic labels corresponding to a plurality of documents clustered into a plurality of topics, wherein the plurality of topic labels include a sentiment-oriented topic label and a sentiment-neutral topic label;
calculating term frequency-inverse document frequency (TF-IDF) values for respective topic labels and corresponding pluralities of documents;
receiving a selected sentiment polarity from a user device;
identifying a subset of the plurality of topic labels that satisfy the selected sentiment polarity; and
transmitting at least one topic label of the subset of the plurality of topic labels to the user device, wherein the at least one topic label has a higher TF-IDF value than other topic labels in the subset of the plurality of topic labels.

16. The computer program product of claim 15, wherein the selected sentiment polarity comprises a neutral sentiment polarity, wherein the method further comprises:
generating a converted corresponding sentiment-neutral topic label corresponding to the sentiment-oriented topic label.

17. The computer program product of claim 16, wherein the subset of the plurality of topic labels includes both the sentiment-neutral topic label and the converted corresponding sentiment-neutral topic label.

18. The computer program product of claim 16, wherein generating the converted corresponding sentiment-neutral topic label utilizes a sentiment dictionary associating sentiment-neutral phrases and sentiment-oriented phrases for similar topics.

19. The computer program product of claim 15, wherein the selected sentiment polarity comprises a non-neutral sentiment polarity, wherein the method further comprises:
removing topic labels with sentiments that do not match the non-neutral sentiment polarity from the plurality of topic labels.

20. The computer program product of claim 19, wherein the method further comprises:
tagging respective documents with respective sentiment tags; and
removing documents from the plurality of documents with sentiment tags that do not match the non-neutral sentiment polarity.

21. A computer-implemented method comprising:
generating a sentiment-neutral topic label for a first plurality of documents clustered into a first topic;
generating a sentiment-oriented topic label for a second plurality of documents clustered into a second topic;
receiving a selected sentiment polarity from a user device, wherein the selected sentiment polarity is a neutral sentiment polarity;
generating a converted corresponding sentiment-neutral topic label corresponding to the sentiment-oriented topic label; and
transmitting the sentiment-neutral topic label and the converted corresponding sentiment-neutral topic label to the user device, wherein the sentiment-neutral topic label and the converted corresponding sentiment-neutral topic label are ranked by term frequency-inverse document frequency (TF-IDF) values.

22. The method of claim 21, wherein generating the converted corresponding sentiment-neutral topic label utilizes a sentiment dictionary associating sentiment-neutral phrases and sentiment-oriented phrases for similar topics.

23. The method of claim 21, wherein the method is performed by one or more computers according to software that is downloaded to the one or more computers from a remote data processing system.

24. The method of claim 23, wherein the method further comprises:
metering a usage of the software; and
generating an invoice based on metering the usage.

25. A computer-implemented method comprising:
generating a plurality of topic labels corresponding to a plurality of documents clustered into a plurality of topics, wherein the plurality of topic labels include a sentiment-oriented topic label and a sentiment-neutral topic label;
calculating term frequency-inverse document frequency (TF-IDF) values for respective topic labels and corresponding pluralities of documents;
removing topic labels from the plurality of topic labels that have a sentiment differing from a corresponding clustered set of documents;
receiving a selected sentiment polarity from a user device;
determining a subset of the plurality of topic labels that satisfy the selected sentiment polarity to the user device; and
presenting the subset of the plurality of topic labels according to the TF-IDF values.
